(19) United States
(12) Patent Application Publication
(10) Pub. No.: US 2025/0209602 A1
(43) Pub. Date: Jun. 26, 2025

(54) METHOD AND APPARATUS FOR CLASSIFYING IRON SCRAP THROUGH IMAGE ANALYSIS

(71) Applicants: LG CNS CO., LTD., Seoul (KR); DaehanSteel, Busan (KR)

(72) Inventors: Hee Jae Lee, Seoul (KR); Sang Jeong Lee, Seoul (KR); Tae Byeong Park, Seoul (KR); Won Young Lee, Seoul (KR); Min Je Jwa, Seoul (KR); Chang Hyun Lee, Busan (KR)

(21) Appl. No.: 18/991,100

(22) Filed: Dec. 20, 2024

(30) Foreign Application Priority Data
Dec. 21, 2023 (KR) 10-2023-0188832

(51) Int. Cl. G06T 7/00; G06T 7/11; G06T 7/194; G06T 11/60; G06V 10/26; G06V 10/764; G06V 10/776; G06V 20/60

(52) U.S. Cl. CPC G06T 7/0004; G06T 7/11; G06T 7/194; G06T 11/60; G06V 10/267; G06V 10/764; G06V 10/776; G06V 20/60; G06T 2207/20212; G06T 2207/30136

(57) ABSTRACT

Disclosed are a method of providing iron scrap classification information through image analysis, and an apparatus for classifying iron scrap and recording medium that performs the method. The method includes obtaining, by a receiving unit, a loaded state image captured in a state in which a plurality of iron scraps are loaded onto a loading device, obtaining, by a processor, segmented images including target iron scrap from the loaded state image using a segmentation model which performs segmentation on the target iron scrap, which is any one of the plurality of iron scraps, obtaining, by the processor, item information and grade information corresponding to the target iron scrap using a classification model which performs classification on the segmented images and performs analysis on the classified images in units of images, and providing, by the processor, iron scrap classification information including the item information and the grade information.

### CROSS-REFERENCE TO RELATED APPLICATION

This application claims priority to and the benefit of Korean Patent Application No. 10-2023-0188832, filed on Dec. 21, 2023, the disclosure of which is incorporated herein by reference in its entirety.

### BACKGROUND

### 1. Field of the Invention

The technical field of the present disclosure relates to a method of providing result information of image classification of objects loaded onto a loading device, a single object, or the like, and more particularly, relates to a method of providing iron scrap classification information based on image analysis for a region including one or more iron scraps.

### 2. Background

Recently, with the growth of the logistics industry, loading devices are being widely used to load various objects or move objects from one place to another place. Typically, the placement of objects loaded onto a loading device is determined by workers based on product type or specifications. However, manually verifying the positions of objects can be challenging and inefficient. To address this, a segmentation method is often employed, where an entire region of the loading device onto which the objects are loaded is divided into a plurality of regions, and images of the regions are monitored.

Generally, in image analysis methods for iron scrap segmentation, an optical system can be easily installed at unloading locations to acquire images without hardware (H/W) engineering to set the position and angle of the optical system (e.g., closed-circuit television (CCTV) and mechanism) for optimal artificial intelligence (AI) performance. However, this approach faces limitations due to the need for extensive image collection and labeling. These challenges arise from the irregular nature of iron scrap, which exhibits inconsistent features such as various shapes (depending on usage), plain textures, various colors (e.g., paint, rust, etc.), and different cutting and bending methods. Instance segmentation, often used to classify such irregular scrap and determine its grade, requires significant effort for data preparation. Therefore, there is a need for an improved image analysis method and system that enhances performance while reducing the amount of image collection and labelling required.

### SUMMARY OF THE INVENTION

The present disclosure is directed to providing a technique for improving the accuracy of image analysis and classification of one or more objects (e.g., iron scraps) in a loaded state image. The technique enables the provision of high-accuracy image classification information for the objects by utilizing an artificial intelligence (AI) model that minimizes the number of images required for collection.

The objectives of the present disclosure are not limited to the above-described purpose, and additional technical objectives may also be addressed.

According to an aspect of the present disclosure, there is provided a method of classifying iron scrap through image analysis, which includes obtaining, by a receiving unit, a loaded state image captured in a state in which a plurality of iron scraps are loaded onto a loading device, obtaining, by a processor, segmented images including target iron scrap from the loaded state image using a segmentation model which performs segmentation on the target iron scrap, which is any one of the plurality of iron scraps, obtaining, by the processor, item information and grade information corresponding to the target iron scrap using a classification model which performs classification on the segmented images and performs analysis on the classified images in units of images, and providing, by the processor, iron scrap classification information including the item information and the grade information.

The obtaining of the item information and the grade information may include obtaining, by the processor, a target iron scrap image representing the target iron scrap by excluding a background region from the segmented image, and performing, by the processor, the classification on the target iron scrap image and obtaining the item information and the grade information.

The method may further include obtaining, by the receiving unit, a correct image representing the target iron scrap, determining, by the processor, a percentage of an overlapping region of the correct image and the target iron scrap image, obtaining, by the processor, an iron scrap determination accuracy indicating whether the target iron scrap image is an actual image of iron scrap when the percentage of the overlapping region exceeds a threshold overlap percentage, obtaining, by the processor, an iron scrap determination accuracy indicating whether the target iron scrap image is an actual image of iron scrap when the percentage of the overlapping region exceeds a threshold overlap percentage, and providing, by the processor, the iron scrap determination accuracy as a performance indicator.

The method may further include determining, by the processor, a target weight determined according to a region size of the target iron scrap image, determining, by the processor, a target accuracy for the target iron scrap image, and applying, by the processor, the target weight to the target accuracy and determining an accuracy for the classification model.

The method may further include obtaining, by the receiving unit, a single segmented image captured for a single iron scrap, obtaining, by the processor, a synthesized image using the loaded state image and the single segmented image, and applying, by the processor, the segmentation model and the classification model to the synthesized image and providing additional iron scrap classification information.

The obtaining of the synthesized image may include obtaining, by the processor, a single iron scrap image by excluding a background region from the single segmented image, and obtaining, by the processor, the synthesized image by combining the loaded state image with the single iron scrap image.

The obtaining of the synthesized image by combining the loaded state image with the single iron scrap image may include determining, by the processor, a number of possible combinations of the single iron scrap image and the loaded state image on the basis of the region size of the single iron scrap image, and obtaining, by the processor, the synthesized image on the basis of the number of possible combinations.

The obtaining of the loaded state image may include obtaining, by the receiving unit, a loaded state image updated by being captured in a state in which positions of the plurality of iron scraps are updated in the loading device onto which a plurality of identical iron scraps are loaded, and the obtaining of segmented image may include obtaining, by the processor, the segmented images including the target iron scrap from the updated loaded state image using the segmentation model.

When a number of pixels included in the target iron scrap image is less than a first number, the target weight may increase in proportion to a linear function corresponding to a first slope, when the number of pixels is greater than or equal to the first number and less than a second number, the target weight may increase in proportion to an exponential function having a base greater than the first slope, when the number of pixels is greater than or equal to the second number, the target weight may increase in proportion to a linear function corresponding to a second slope smaller than the first slope, and the first slope and the second slope may have positive numbers.

The providing of the iron scrap classification information may include obtaining, by the processor, average weight information indicating a cumulative area and/or cumulative number for each item and grade for the item information and grade information that correspond to the target iron scrap among the plurality of iron scraps, and providing, by the processor, a circular graph showing a cumulative area ratio and/or cumulative number ratio for each item and grade for the target iron scrap in the loaded state image on the basis of the average weight information.

According to another aspect of the present disclosure, there is provided an apparatus for classifying iron scrap through image analysis, which includes a receiving unit configured to obtain a loaded state image captured in a state in which a plurality of iron scraps are loaded onto a loading device, and a processor that is configured to obtain segmented images including target iron scrap from the loaded state image using a segmentation model which performs segmentation on the target iron scrap, which is any one of the plurality of iron scraps, obtain item information and grade information corresponding to the target iron scrap using a classification model which performs classification on the segmented images and performs analysis on the classified images in units of images, and provide iron scrap classification information including the item information and the grade information.

The processor may obtain a target iron scrap image representing the target iron scrap by excluding a background region from the segmented image, and perform the classification on the target iron scrap image and obtain the item information and the grade information.

The receiving unit may obtain a correct image representing the target iron scrap, and the processor may determine a percentage of an overlapping region of the correct image and the target iron scrap image, obtain an iron scrap determination accuracy indicating whether the target iron scrap image is an actual image of iron scrap when the percentage of the overlapping region exceeds a threshold overlap percentage, provide the iron scrap determination accuracy as a performance indicator, determine a target weight determined according to a region size of the target iron scrap image, determine a target accuracy for the target iron scrap image, and apply the target weight to the target accuracy and determine an accuracy for the classification model.

The receiving unit may obtain a single segmented image captured for a single iron scrap, and the processor may obtain a synthesized image using the loaded state image and the single segmented image, and apply the segmentation model and the classification model to the synthesized image and provide additional iron scrap classification information.

According to still another aspect of the present disclosure, there is provided a computer-readable non-transitory recording medium on which a program for implementing the method of the first aspect is recorded.

### BRIEF DESCRIPTION OF THE DRAWINGS

The above and other aspects, features and advantages of the present disclosure will become more apparent to those of ordinary skill in the art by describing exemplary embodiments thereof in detail with reference to the accompanying drawings, in which: FIG. 1 is a block diagram schematically illustrating an apparatus for classifying objects through image analysis according to an embodiment of the present disclosure;

FIG. 2 is a flowchart illustrating operations in which the apparatus for classifying the iron scrap according to an embodiment of the present disclosure provides iron scrap classification information;

FIG. 3 is a flowchart schematically illustrating operations in which the apparatus for classifying the iron scrap according to an embodiment of the present disclosure performs image analysis on iron scraps according to a layer change;

FIG. 4 is a diagram schematically showing an example in which the apparatus for classifying the iron scrap according to an embodiment of the present disclosure performs segmentation and classification;

FIG. 5 is a diagram illustrating an example in which the apparatus for classifying the iron scrap according to an embodiment of the present disclosure performs an accuracy evaluation on a classification model;

FIG. 6 is a diagram illustrating an example in which the apparatus for classifying the iron scrap according to an embodiment of the present disclosure obtains item information and grade information of each iron scrap based on results of imaging a plurality of iron scraps in a loading device or a single iron scrap;

FIG. 7 is a diagram illustrating an example in which the apparatus for classifying the iron scrap according to an embodiment of the present disclosure augments data based on results of imaging one iron scrap in the loading device or a single iron scrap;

FIG. 8 is a diagram illustrating an example in which the apparatus for classifying the iron scrap according to an embodiment of the present disclosure performs segmentation on a synthesized image;

FIG. 9 is a diagram illustrating an example in which the apparatus for classifying the iron scrap according to an embodiment of the present disclosure performs segmentation on an updated loaded state image;

FIG. 10 is a diagram schematically showing an example in which the apparatus for classifying the iron scrap according to an embodiment of the present disclosure provides iron scrap classification information; and

FIG. 11 shows a simplified diagram of a device that corresponds to the apparatus illustrated in FIG. 1, according to an embodiment of the present disclosure.

### DETAILED DESCRIPTION OF EXEMPLARY EMBODIMENTS

A detailed description of embodiments is provided below along with accompanying figures. The scope of this disclosure is limited by the claims and encompasses numerous alternatives, modifications and equivalents. Although steps of various processes are presented in a given order, embodiments are not necessarily limited to being performed in the listed order. In some embodiments, certain operations may be performed simultaneously, in an order other than the described order, or not performed at all.

Terms used herein are provided only to describe the embodiments of the present disclosure and not for purposes of limitation. In this specification, the singular forms include the plural forms unless the context clearly indicates otherwise. It will be understood that terms “comprise” and/or “comprising” used herein specify some stated components, but do not preclude the presence or addition of one or more other components. Like reference numerals throughout the specification denote like components, and “and/or” includes each and every combination of one or more of the above-describe components. It should be understood that, although the terms “first,” “second,” etc., may be used herein to describe various components, these components are not limited by these terms. The terms are only used to distinguish one component from another component. Therefore, it should be understood that a first component to be described below may be a second component within the technical scope of the present disclosure.

Unless otherwise defined, all terms including technical and scientific terms used herein have the same meaning as commonly understood by those skilled in the art. Further, it should be further understood that terms, such as those defined in commonly used dictionaries, should not be interpreted in an idealized or overly formal sense unless expressly so defined herein.

Spatially relative terms “below,” “beneath,” “lower,” “above,” “upper,” etc., may be used to facilitate the description of a relationship between one component and other components as illustrated in the accompanying drawings. The spatially relative terms should be understood to include different directions of the element during use or operation in addition to the direction illustrated in the accompanying drawings. For example, when a component illustrated in the drawing are flipped, a component described as “below” or “beneath” another component may end up being placed “above” the other component. Therefore, an exemplary term “below” may include both downward and upward directions. Components may be arranged in different directions so that spatially relative terms may be interpreted according to the arrangement.

Hereinafter, embodiments will be described in detail with reference to the accompanying drawings.

FIG. 1 is a block diagram schematically illustrating an apparatus 100 for classifying objects through image analysis according to an embodiment of the present disclosure. In an embodiment, the objects may include iron scraps. For example, the following description will provide iron scraps as the objects to be classified.

Referring to FIG. 1, the apparatus 100 may include a receiving circuit (or unit) 110 and a processor 120.

The receiving circuit 110 may obtain a loaded state image captured in a state where a plurality of iron scraps are loaded onto a loading device. In an embodiment, the receiving circuit 110 may receive the loaded state image as electrical signals such as analog or digital signals.

The processor 120 may obtain segmented images of a target iron scrap from the loaded state image using a segmentation model, wherein the target iron scrap is one of the plurality of iron scraps. Further, the processor 120 may obtain item information and grade information that correspond to the target iron scrap by classifying the segmented images using a classification model. Additionally, the processor 200 may analyze the classified images in units of images and provide iron scrap classification information, including the item information and the grade information.

Further, the apparatus 100 may be integrated with various conventional networks, such as the Internet, a mobile communication network, etc. These networks can be utilized during the process in which the receiving circuit 110 obtains the loaded state image, and the processor 120 obtains the segmented images of the target iron scrap by performing segmentation on the loaded state image, obtains the item information and grade information that correspond to the segmented images by performing classification, and provides the iron scrap classification information including the item information and the grade information. Tt should be noted that there is no special limitation regarding the types of networks that can be used.

In addition, it should be understood by those skilled in the art that other general components other than those illustrated in FIG. 1 may be further included in the apparatus 100. For example, the apparatus 100 may further include a memory (not illustrated) that stores the loaded state image, the segmented images, the item information and grade information that correspond to the segmented images, etc., and may further include a transmitting circuit (not illustrated) that transmits the iron scrap classification information or a display circuit (not illustrated) that displays the iron scrap classification information. Alternatively, it will be understood by those skilled in the art that in another embodiment, some of the components illustrated in FIG. 1 may be omitted.

The apparatus 100 may be used by a user, may be linked with any type of handheld-based wireless communication devices equipped with a touch screen panel, such as a mobile phone, a smartphone, a personal digital assistant (PDA), a portable multimedia player (PMP), a tablet computer, etc. Additionally, the apparatus 100 may be integrated with or connected to a device capable of installing and running applications, such as a desktop personal computer (PC), a tablet computer, a laptop computer, an Internet Protocol television (IPTV) with a set-top box, or the like.

The apparatus 100 may be implemented as a terminal such as a computer or the like that operates through a computer program to realize the functions described in this specification.

The apparatus 100 may include a system (not illustrated) that provides the iron scrap classification information and a related server (not illustrated), but the present disclosure is not limited thereto. According to an embodiment, the server may support an application that provides the iron scrap classification information.

Hereinafter, an example is described in which the apparatus 100 independently obtains and provides classification result information based on a preset classification method. However, as described above, the apparatus 100 may perform the above function in conjunction with the server. Specifically, the apparatus 100 and the server may be functionally integrated, or the server may be omitted. Accordingly, the present disclosure is not limited to any particular embodiment.

In an embodiment, the apparatus 100 and the server may be linked with each other to perform a process of classifying iron scraps and a process for providing classification results, either by the server or by the apparatus 100. For example, the apparatus 100 may operate as a server, and in such cases, the apparatus 100 and the server will hereinafter be collectively referred to as the apparatus 100.

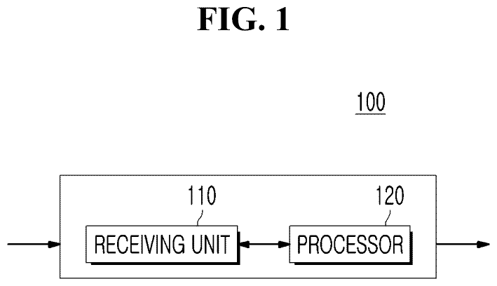

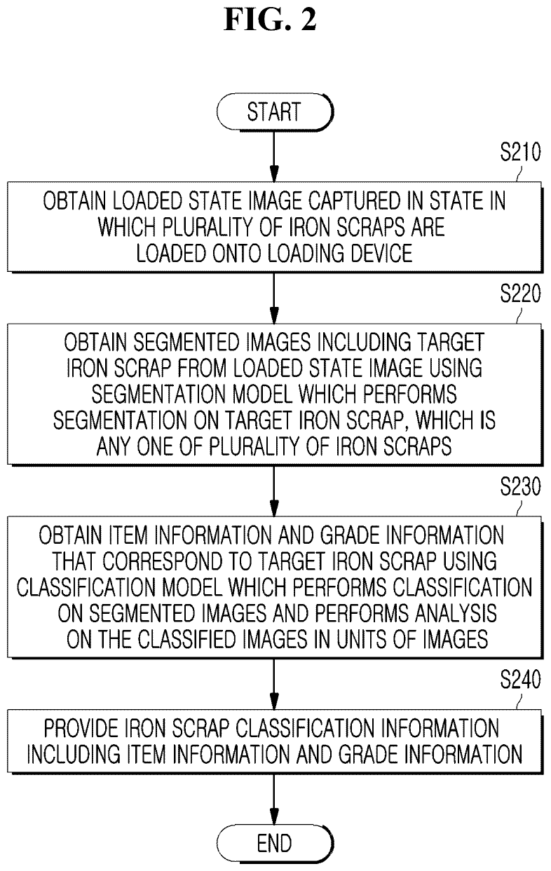

FIG. 2 is a flowchart illustrating operations in which the apparatus 100 provides iron scrap classification information.

Referring to operation S210, the apparatus 100 may obtain a loaded state image captured in the state where a plurality of iron scraps are loaded onto a loading device. In an embodiment, the apparatus 100 may receive, by the receiving circuit 110, the loaded state image captured by a camera (not illustrated) positioned above the loading device, looking down at it. Therefore, the apparatus 100 may obtain the loaded state image including the plurality of iron scraps.

Referring to operation S220, the apparatus 100 may generate segmented images including a target iron scrap from the loaded state image using a segmentation model, wherein the target iron scrap is one of the plurality of iron scraps. In an embodiment, the segmentation model may include semantic segmentation and instance segmentation. In an embodiment, the apparatus 100 may obtain scrap regions corresponding to each of the plurality of iron scraps by performing segmentation on the loaded state image. When the apparatus 100 performs the segmentation using the semantic segmentation, the apparatus 100 may classify the plurality of iron scraps by assigning pixels of the loaded state image to physical units. Specifically, the apparatus 100 may segment the iron scrap in any one region among a plurality of iron scrap regions at the pixel level, thereby classifying each of the plurality of iron scraps included in the loaded state image as individual iron scrap units.

Analysis of scrap regions based on results of performing semantic segmentation may be performed at the pixel level. For example, the apparatus 100 may obtain a quadrangular region including at least one pixel corresponding to each of the plurality of iron scraps as a scrap region. Therefore, the apparatus 100 may generate the segmented image, which is an image corresponding to each scrap region extracted from the loaded state image. In an embodiment, each scrap region representing a target iron scrap, which is one of the plurality of iron scraps, may correspond to the segmented image. Therefore, the apparatus 100 may obtain a plurality of segmented images for the target iron scrap using the segmentation model.

Referring to operation S230, the apparatus 100 may obtain item information and grade information that correspond to the target iron scrap using a classification model, which performs classification on the segmented images and performs analysis on the classified images in units of images. In an embodiment, the classification may be a process of analyzing or classifying iron scraps based on feature information extracted from each image for each segmented image. Specifically, the apparatus 100 may analyze the plurality of segmented images obtained in operation S220 using the classification model in units of images. Therefore, the apparatus 100 may obtain item information and grade information that correspond to each analyzed image. In an embodiment, the item information corresponds to characteristic information on the iron scrap, and may include, for example, heavy weight iron scrap information, light weight iron scrap information, etc.

Further, in an embodiment, the apparatus 100 may obtain the grade information together with the item information corresponding to the target iron scrap by performing classification on a target iron scrap image. Further, the apparatus 100 for may obtain the target iron scrap image representing the target iron scrap by excluding a background region from the segmented image. The segmented image obtained in operation S220 may include a background region other than the target iron scrap. In an embodiment, the background region may include a wall region of the loading device, a border region of the loading device, etc. Therefore, to ensure accuracy, the apparatus 100 may obtain the target iron scrap image representing the target iron scrap, excluding the background region from the segmented images, and obtain item information and grade information on the target iron scrap by performing classification on the target iron scrap image. Therefore, in obtaining the item information and the grade information on the target iron scrap, it is possible to prevent errors in analysis results caused by background interference.

Further, in an embodiment, the apparatus 100 may perform an evaluation process on the segmentation model. The apparatus 100 may obtain a correct image. In an embodiment, the correct image may represent a correct answer for the iron scrap obtained from a user terminal or an external server. That is, the correct image may correspond to an actual iron scrap region that can be used to check whether the image corresponds to the actual iron scrap region obtained from the user terminal or the external server for the plurality of iron scraps.

The apparatus 100 may determine a percentage of an overlapping region of the correct image and the target iron scrap image. For example, the target iron scrap image may be an image in which the background region is excluded from the segmented image obtained using the segmentation model. Therefore, the target iron scrap image may be identical to the correct image representing the actual iron scrap, but may be different depending on a result of performing the segmentation. The apparatus 100 may determine the percentage of the overlapping region of the correct image and the target iron scrap image. When the percentage of the overlapping region exceeds a threshold overlap percentage, the apparatus 100 may obtain an iron scrap determination accuracy indicating whether the target iron scrap image is an actual image of iron scrap.

In an embodiment, the threshold overlap percentage may represent a minimum criterion overlap percentage at which the obtained target iron scrap image may be predicted to correspond to the actual iron scrap. That is, the apparatus 100 may determine that the target iron scrap image corresponds to the actual iron scrap when the percentage of the overlapping region of the correct image and the target iron scrap image exceeds the threshold overlap percentage (e.g., 50 percent), and in this case, the apparatus 100 may obtain the iron scrap determination accuracy indicating whether the corresponding target iron scrap image is an actual image of iron scrap.

The apparatus 100 may provide the iron scrap determination accuracy as a performance indicator. For example, in an embodiment, the threshold overlap percentage is a ratio that can be predicted to correspond to actual iron scrap, and may correspond to a criterion for primary sorting. That is, the apparatus 100 may determine that the iron scrap is not iron scrap because the target iron scrap image is predicted not to correspond to iron scrap when the percentage of the overlapping region is lower than or equal to the threshold overlap percentage, and may primarily determine that the corresponding iron scrap is a predicted iron scrap because the target iron scrap image is predicted to correspond to iron scrap when the percentage of the overlapping region exceeds the threshold overlap percentage. Therefore, the apparatus 100 may obtain the iron scrap determination accuracy, which indicates whether the predicted iron scrap image primarily determined as the predicted iron scrap is the actual image of iron scrap.

For example, the apparatus 100 may check whether the predicted iron scrap image is an image for intact iron scrap. Specifically, when the region including the wall image of the loading device, the border image of the loading device, etc., which is not the iron scrap in the predicted iron scrap image, is greater than or equal to a preset percentage or when the extent that the predicted iron scrap image corresponds to the actual iron scrap is less than the preset percentage, the apparatus 100 may determine that the image is not the actual image of iron scrap. The apparatus 100 may obtain the iron scrap determination accuracy indicating whether the image is an image for iron scrap to provide the performance indicator for the segmentation model.

The apparatus 100 may perform segmentation using a segmentation model corresponding to when the iron scrap determination accuracy is greater than or equal to the preset percentage (e.g., 90 percent to 95 percent or more). That is, the apparatus 100 may determine the performance of the segmentation model corresponding to when the iron scrap determination accuracy is less than the preset percentage as a lower performance, and thus may not apply the corresponding segmentation model as a model for performing segmentation.

In another embodiment, the apparatus 100 may update the preset percentage corresponding to the iron scrap determination accuracy according to the threshold overlap percentage. For example, the apparatus 100 may perform an evaluation on the segmentation model only for percentages adjacent to the threshold overlap percentage by increasing the preset percentage corresponding to the iron scrap determination accuracy by a certain level (e.g., from 90 percent to 95 percent or more to 93 percent to 98 percent or more) when the threshold overlap percentage corresponds to an adjacent percentage of the preset percentage (e.g., from 48 percent or more adjacent to 50 percent to less than 50 percent).

Further, the apparatus 100 may perform an evaluation process on the classification model. The apparatus 100 may determine a target weight determined according to a region size of the target iron scrap image. The apparatus 100 may determine a target accuracy for the target iron scrap image. Further, the apparatus 100 may determine the accuracy for the classification model by applying the target weight to the target accuracy.

In an embodiment, the target accuracy for the target iron scrap image may include the iron scrap determination accuracy indicating whether the image is the actual iron scrap as described above, and may further include an item accuracy and grade accuracy for the item information and grade information that correspond to each target iron scrap obtained in operation S230.

That is, the apparatus 100 may determine the target accuracy indicating whether the obtained item information and grade information correspond to an actual item and grade for the target iron scrap. Therefore, the apparatus 100 may determine the target accuracy and then update the target accuracy according to the region size of the target iron scrap image.

For example, the apparatus 100 may determine target weights that are differently assigned to each of a plurality of target iron scrap images. The apparatus 100 may assign a higher weight to iron scrap having a large region size of the target iron scrap image. In an embodiment, since the model may be more suitable for accurately determining iron scrap having a large size and a high error rate, the apparatus 100 for may determine the accuracy for the classification model based on the updated target accuracy by assigning a higher weight to the iron scrap having a large region size of the target iron scrap image.

For example, the apparatus 100 may determine the target weight to increase linearly in proportion to the region size of the target iron scrap image. In another embodiment, the apparatus 100 may determine differently the degree of increase in proportion to a preset region size range when semantic segmentation is performed. For example, when the number of pixels included in the target iron scrap image is less than a first number, the target weight may increase in proportion to a linear function corresponding to a first slope. When the number of pixels is greater than or equal to the first number and less than a second number, the target weight may increase in proportion to an exponential function having a base greater than the first slope. When the number of pixels is greater than or equal to the second number, the target weight may increase in proportion to a linear function corresponding to a second slope smaller than the first slope, and the first slope and the second slope may have positive numbers.

For example, the apparatus 100 may determine the region size of the target iron scrap image based on the number of pixels. Therefore, when the number of pixels included in the target iron scrap image is less than the first number, which is a preset number, the target weight may be determined to increase in proportion to a linear function corresponding to the first slope.

Further, when the number of pixels included in the target iron scrap image is greater than or equal to the first number and less than the second number, the target weight may be determined to increase in proportion to an exponential function. In an embodiment, the first slope may correspond to a constant corresponding to a linear function. The apparatus 100 may apply an exponential function having a base greater than the constant corresponding to the first slope to a range in which the number of pixels is greater than or equal to the first number and less than the second number. Specifically, the extent that the target weight increases when the number of pixels is greater than or equal to the first number and less than the second number may be greater than the extent that the target weight increases when the number of pixels is less than the first number.

Further, in order to determine the target weight, the apparatus 100 may apply a linear function corresponding to the second slope smaller than the first slope when the number of pixels included in the target iron scrap image is greater than or equal to the second number. In an embodiment, the second slope may correspond to a constant corresponding to a linear function or may correspond to a constant smaller than the constant corresponding the first slope. Specifically, the extent that the target weight increases when the number of pixels is greater than or equal to the second number may be smaller again than the extent that the target weight increases when the number of pixels is greater than or equal to the first number and less than the second number.

Further, the constant corresponding to each of the first slope, the base of the exponential function, and the second slope may have a positive number. Therefore, the extent that the target weight increases may be determined and applied differently depending on the range that includes the region size of the target iron scrap image. In this case, the extent that the target weight increases when the number of pixels is greater than or equal to the second number may be the smallest, and the extent that the target weight increases when the number of pixels is greater than or equal to the first number and less than the second number may be the largest.

Therefore, the apparatus 100 has an effect of more appropriately determining the accuracy of the classification model by differently determining the weight according to the region size based on the number of pixels when the semantic segmentation is performed. In an embodiment, the region that is greater than or equal to the first number and less than the second number may be the widest range of region, which may include the largest amount of iron scrap. In this case, the apparatus 100 may apply an exponential function to the extent that the target weight increases as the importance of the size of the corresponding region is determined to be higher, so that the weight according to the size (area) of the region is further applied.

Further, in an embodiment, a larger region size may have a greater impact on classification accuracy. However, since the sizes of the plurality of iron scraps corresponding to when the number of pixels is greater than or equal to the second number may correspond to a case in which the sizes of the plurality of iron scraps are all greater than the size of the reference range, it may not be very meaningful to make a large difference between the plurality of iron scraps.

Further, since the sizes of the plurality of iron scraps corresponding to when the number of pixels is less than the first number may correspond to a case in which the sizes of the plurality of iron scraps are smaller than the size of the reference range, it may be meaningful to make the difference between the plurality of iron scraps within a range larger than when the number of pixels is greater than or equal to the second number. Therefore, the apparatus 100 may determine the accuracy for the classification model by determining the extent that the target weight increases to be increased in the order of a range in which the number of pixels is greater than or equal to the first number and less than the second number, a range in which the number of pixels is less than the first number, and a range in which the number of pixels is greater than or equal to the second number. Therefore, the apparatus 100 may obtain the accuracy for the classification model to perform classification using a classification model corresponding to when the classification model accuracy is greater than or equal to the preset percentage. That is, the apparatus 100 may perform the classification using the classification model that shows a high target accuracy for iron scrap with a large region size of the target iron scrap image.

Referring to operation S240, the apparatus 100 may provide the iron scrap classification information including the item information and the grade information. As described above, the apparatus 100 may provide the item information and grade information on the target iron scrap obtained using the segmentation model and the classification model, as the iron scrap classification information.

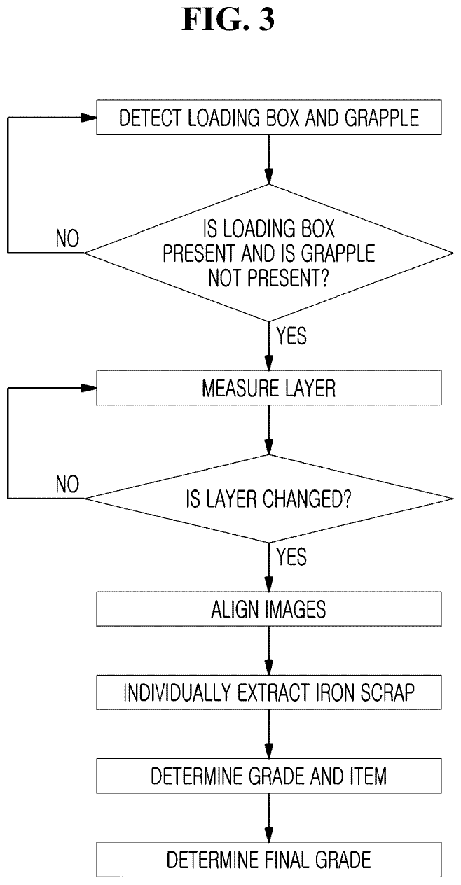

FIG. 3 is a flowchart schematically illustrating operations in which the apparatus 100 performs image analysis on the iron scrap according to a layer change.

Referring to FIG. 3, the apparatus 100 f may determine whether there is a loading device (or loading box) and a grapple. A layer may be measured when the loading device is present and the grapple is not present. Further, image alignment may be performed only when the layer is measured and then the layer change is performed. Segmented images may be obtained by individually extracting iron scrap through the segmentation process described above in operation S220. Subsequently, item information and grade information for each iron scrap may be obtained through the classification process described above in operation S230, allowing a final grade to be assigned to each iron scrap.

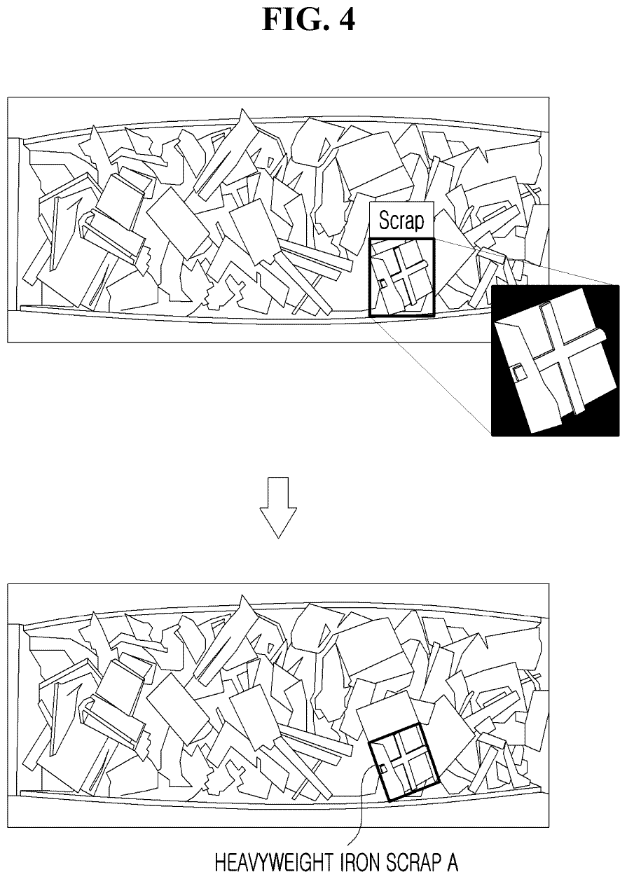

FIG. 4 is a diagram schematically showing an example in which the apparatus 100 performs segmentation and then performs classification.

Referring to FIG. 4, the apparatus 100 may generate segmented images by individually extracting a plurality of iron scraps into scrap regions at the pixel level using a segmentation model. Further, the apparatus 100 may obtain a target iron scrap image representing a target iron scrap by excluding a background region from the segmented image. Accordingly, as shown in a lower part of FIG. 4, classification may be performed on the target iron scrap image from which the background region is excluded, enabling the apparatus 100 to determine item information and grade information specific to the target iron scrap.

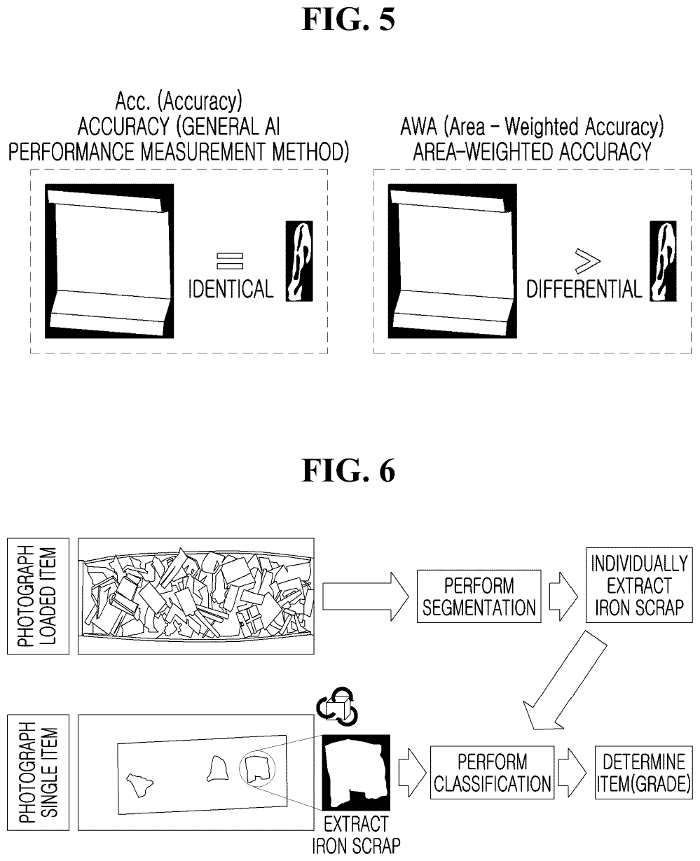

FIG. 5 is a diagram illustrating an example in which the apparatus 100 performs an accuracy evaluation on a classification model.

Referring to FIG. 5, the apparatus 100 may assign different target weights based on a region size of a target iron scrap image. On the left side of FIG. 5, an artificial intelligence (AI) performance measurement method is shown, representing a general accuracy measurement method (Acc-accuracy), where an equal evaluation is performed by assigning the same weight to analysis results of both large-sized iron scrap and small-sized iron scrap. For the general accuracy measurement method, the accuracy is calculated using an equation of the number of correct answers/total number.

In contrast, an embodiment applies an area-weighted accuracy (AWA) area weighted accuracy method, which measures the accuracy by differentially assigning target weights according to the region size (area size). For the AWA method, the accuracy is calculated using the equation of the number of pixels in a correct area/the number of pixels in an entire area. By employing the AWA method, the apparatus 100 may perform classification according to a model that determines the importance of large-sized iron scrap. This approach enables the apparatus 100 to assess the accuracy of the classification model by prioritizing larger scrap regions, thereby providing a more nuanced evaluation of the model's performance.

FIG. 6 is a diagram illustrating an example in which the apparatus 100 obtains item information and grade information of each iron scrap based on results of imaging a plurality of iron scraps included in a loading device or a single iron scrap.

Referring to FIG. 6, the apparatus 100 may obtain a loaded state image captured in the state where the plurality of iron scraps are loaded into the loading device, as described above in operation S210, or may obtain a single segmented image captured at multiple angles for a single iron scrap, as shown in a lower part of FIG. 6. Therefore, the apparatus 100 may obtain segmented images by individually extracting iron scraps from the loaded state image by performing segmentation using a segmentation model, and may obtain item information and grade information that correspond to a target iron scrap by individually extracting the iron scraps from the loaded state image by performing classification on the segmented images using a classification model.

Further, when the apparatus 100 obtains the single segmented image, the apparatus 100 may obtain item information and grade information that correspond to the single iron scrap by performing classification on the single segmented image using the classification model. Therefore, item matching information matching an image and its item information for each iron scrap may be obtained and stored in a database.

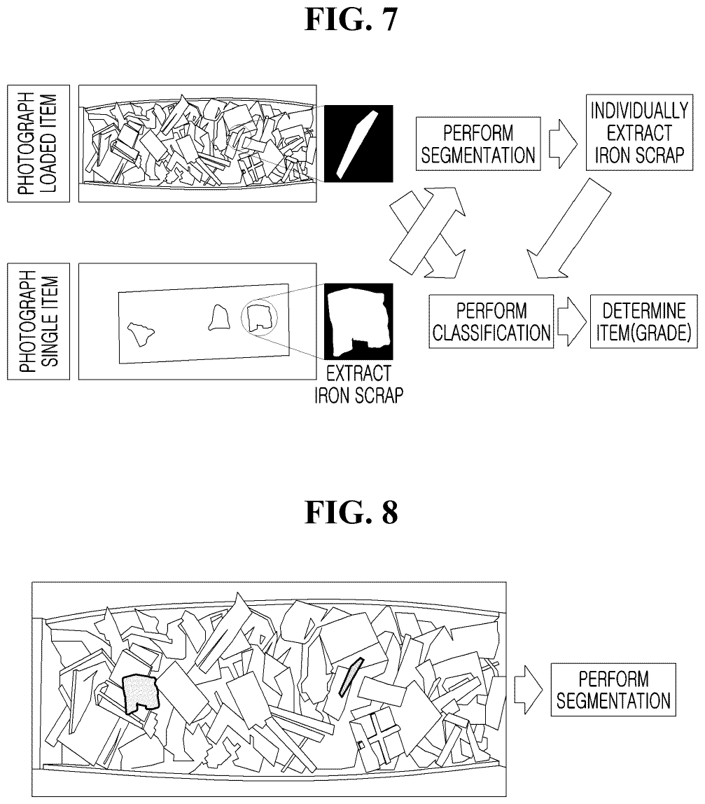

FIG. 7 is a diagram illustrating an example in which the apparatus 100 augments data based on results of imaging one iron scrap included in the loading device or a single iron scrap.

Referring to FIG. 7, the apparatus 100 may obtain item information and grade information that correspond to each target iron scrap by extracting the target iron scrap, wherein the target iron scrap is one of a plurality of iron scraps loaded onto the loading device, and individually performing classification on the target iron scrap. The apparatus 100 may store the obtained item information and grade information in a database.

Further, the apparatus 100 may not directly perform classification on a single segmented image captured for a single iron scrap. Instead, the apparatus 100 may perform segmentation and classification on a newly obtained image derived from performing classification on a loaded state image. Consequently, the apparatus 100 may store the obtained information in the database for future reference. This process will be described with reference to FIG. 8.

FIG. 8 is a diagram illustrating an example in which the apparatus 100 performs segmentation on a synthesized image.

Referring to FIG. 8, the apparatus 100 may obtain the synthesized image based on a loaded state image and a single segmented image. The apparatus 100 may obtain a single iron scrap image by excluding a background region from the single segmented image. Further, the apparatus 100 may obtain the synthesized image by combining the loaded state image and the single iron scrap image.

As shown in FIG. 8, a single iron scrap corresponding to a hatching region may be combined into the loaded state image. Therefore, the apparatus 100 may perform segmentation based on the obtained synthesized image by accumulating the single segmented image on the loaded state image.

The apparatus 100 may provide additional iron scrap classification information including item information and grade information that correspond to a target iron scrap obtained by applying a segmentation model and a classification model to the synthesized image. In another embodiment, the apparatus 100 may determine the number of possible combinations for a single iron scrap to be synthesized into the loaded state image based on the region size of the single iron scrap image.

Further, the apparatus 100 may obtain a synthesized image based on the number of possible combinations. For example, the apparatus 100 may first obtain a synthesized image in which a single iron scrap image is combined with the loaded state image and then obtain a synthesized image in which a plurality of single iron scrap images are combined. For example, when a ratio of the number of pixels included in the single iron scrap image to the total number of pixels in a cross-sectional region corresponding to the loading device is less than a first percentage (e.g., 10 percent), the apparatus 100 may determine the number of possible combinations so that the single iron scrap image may be combined into two or more regions for each region where a horizontal length of the loading device is divided by a first value (e.g., five).

For example, the apparatus 100 may be configured to allow the single iron scrap image to be overlapped and combined in a first region (e.g., five regions) obtained by dividing the horizontal length of the loading device by the first value. That is, in this case, the apparatus 100 may obtain a plurality of synthesized images by determining the number of possible combinations to be one of two to five.

Further, when a ratio of the number of pixels included in the single iron scrap image to the total number of pixels in the cross-sectional region corresponding to the loading device is greater than or equal to the first percentage and less than a second percentage (e.g., 20 percent), the apparatus 100 may determine the number of possible combinations so that the single iron scrap image may be combined into two or more regions for each region in which the horizontal length of the loading device is divided by a second value (e.g., three) smaller than the first value.

For example, the apparatus 100 may be configured to allow the single iron scrap image to be overlapped and combined in a second region (e.g., three regions) obtained by dividing the horizontal length of the loading device by the second value. That is, in this case, the apparatus 100 may obtain a plurality of synthesized images by determining the number of possible combinations to be one of two or three.

Further, when the ratio of the number of pixels included in the single iron scrap image to the total number of pixels in the cross-sectional region corresponding to the loading device is greater than or equal to the second percentage, the apparatus 100 may determine the number of possible combinations so that the single iron scrap image may be combined into two regions for each region in which the horizontal length of the loading device is divided by a third value (e.g., two) smaller than the second value.

For example, the apparatus 100 may be configured to allow the single iron scrap image to be overlapped and combined in a third region (e.g., two regions) obtained by dividing the horizontal length of the loading device by the third value. That is, in this case, the apparatus 100 may further obtain one synthesized image by determining the number of possible combinations to be two. Therefore, the apparatus 100 may perform more data augmentation using the data augmentation process described above.

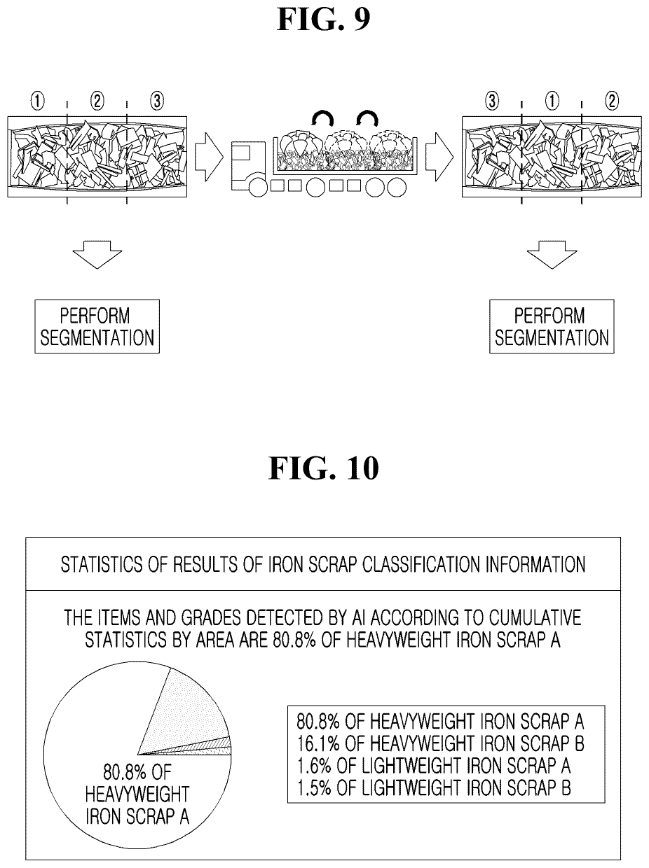

FIG. 9 is a diagram illustrating an example in which the apparatus 100 performs segmentation on an updated loaded state image.

Referring to FIG. 9, the apparatus 100 may obtain a loaded state image updated to reflect positions of a plurality of iron scraps after being rearranged on a loading device. Specifically, the apparatus 100 may obtain an updated loaded state image that is newly captured after the positions of the plurality of iron scraps are changed using a grapple. Further, the apparatus 100 may generate segmented images, including a target iron scrap, from the updated loaded state image using a segmentation model.

Referring to FIG. 9, the apparatus 100 may obtain the loaded state image updated to reflect changes in the positions of the plurality of iron scraps, which are rearranged using the grapple. Additionally, the apparatus 100 may generate an updated loaded state image by dividing the region of the original loaded state image and rearranging the respective image regions in a different order. By capturing a new image reflecting the updated positions of the iron scraps on the loading device, the apparatus 100 may perform segmentation on the updated loaded state image. This process enables the apparatus 100 to conduct enhanced data augmentation, improving the classification accuracy and robustness.

FIG. 10 is a diagram schematically showing an example in which the apparatus 100 provides iron scrap classification information.

Referring to FIG. 10, the apparatus 100 may obtain average weight information indicating a cumulative area and/or cumulative number of items and grades for each of item information and grade information that correspond to a target iron scrap among a plurality of iron scraps. Further, the apparatus 100 may provide a circular graph showing a cumulative area ratio and/or cumulative number ratio for each item and grade for the target iron scrap in a loaded state image based on the average weight information. For each target iron scrap, the apparatus 100 may provide not only the grade information but also the item information.

For example, the apparatus 100 may provide information on a heavy weight iron scrap, a light weight iron scrap, etc., which indicate items for an iron scrap, in addition to grade A, grade B, etc., which indicate grades for an iron scrap. The apparatus 100 may accumulate all the determined results for the entire loading device and finally calculate the area (or number). Further, the apparatus 100 may measure not only the area ratio but also the weight of each grade by tabulating the average weight information for each area of each grade/item. According to an embodiment, the apparatus 100 may provide not only grade information but also item information unlike conventional related art, and thus the apparatus 100 has an effect of facilitating application to countries (by country or by steelmaker) that have the same item but different grades.

According to an embodiment, a high-performance iron scrap classification process can be provided based on a small number of collected images by performing image analysis and image classification using a segmentation model and a classification model. Further, in providing iron scrap classification information, there is an advantage in that effective data augmentation for iron scrap images is possible because processes are performed separately for segmentation and classification, and the accuracy of results of classification can be improved because an image for iron scrap and image classification information are obtained by performing an evaluation process for the segmentation model and the classification model.

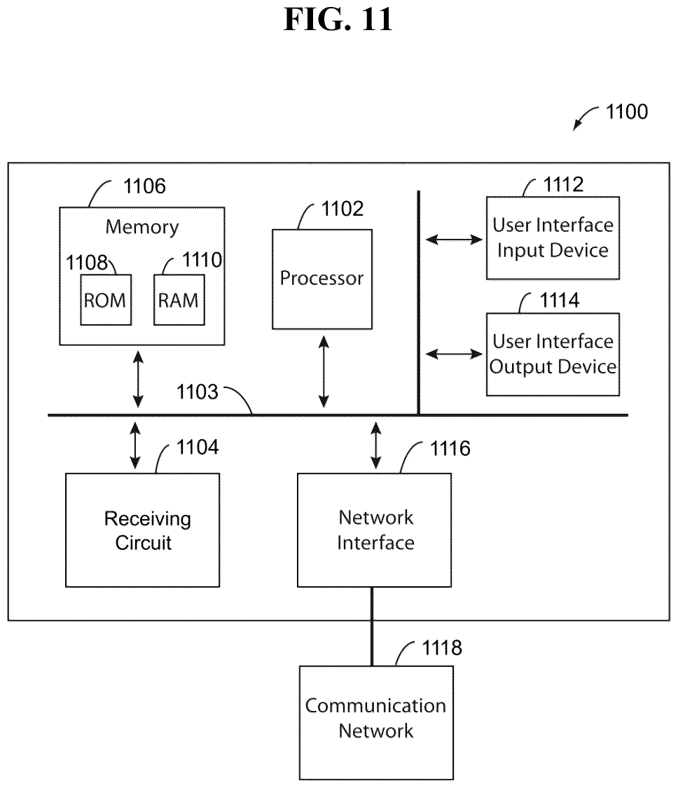

FIG. 11 shows a simplified diagram of a device 1100 that corresponds to the device 100 illustrated in FIG. 1, according to an embodiment of the present disclosure. The device 1100 comprises a processor 1102 and a receiving circuit 1104 that are in communication with each other via a bus 1103. The device 1100 may also include a memory 1106. The memory 1106 may include a Read Only Memory (ROM) 1108 and a Random Access Memory (RAM) 1110. The device 1100 may further include a user interface input device 1112 (e.g., a keyboard, mouse, or touch screen) and a user interface output device 1114 such as a display screen. In an implementation, the user interface input device 1112 and the user interface output device 1114 may be integrated together, e.g., a touch display screen. A network interface 1116 is configured to allow information to be communicated between the device 1100 and a loading device (not shown) via a communications network 1118.

Various embodiments of the present disclosure may be implemented as software including one or more instructions stored in a storage medium (e.g., a memory) that can be read by a machine (e.g., a display device or a computer). For example, a processor (e.g., the processor 120) of the machine may call at least one of the stored instructions from the storage medium and execute the instruction. This enables the device to operate to perform at least one function in accordance with the at least one called instruction. The one or more instructions may include code generated by a compiler or code executable by an interpreter. The storage medium readable by the device may be provided in the form of a non-transitory storage medium. Here, the term “non-transitory” means only that the storage medium is a tangible device and does not contain signals (e.g., electromagnetic waves), and this term does not distinguish between a case where data is stored semi-permanently and a case where data is stored temporarily in the storage medium.

According to an embodiment, the method according to various embodiments disclosed in the present disclosure may be included in a computer program product and provided. The computer program product may be traded between a seller and a buyer as a commodity. The computer program product may be distributed in the form of a machine-readable storage medium (e.g., a compact disc read-only memory (CD-ROM)), or may be distributed online (e.g., by download or upload) through an application store (e.g., Play Store™) or directly between two user devices (e.g., smartphones). In the case of online distribution, at least a portion of the computer program product may be temporarily stored or temporarily generated in a machine-readable storage medium, such as a memory of a manufacturer's server, an application store's server, or an intermediary server.

According to an embodiment of the present disclosure, a high-performance iron scrap classification process can be provided using a segmentation model and a classification model, enabling efficient image analysis and classification based on a small number of collected images.

Further, the separation of segmentation and classification processes provides an advantage by facilitating effective data augmentation for iron scrap images, enhancing the robustness of the classification system.

Further, classification accuracy can be improved by incorporating an evaluation process for both the segmentation model and the classification model, ensuring precise extraction of iron scrap images and reliable classification information.

Effects of the present disclosure are not limited to the above-described effects and other effects that are not described may be clearly understood by those skilled in the art from the above detailed descriptions.

While the present disclosure has been described with reference to the accompanying drawings, it is not limited to the disclosed embodiments and drawings, and it will be understood by those skilled in the art that various changes in form and details may be made without departing from the spirit and scope of the present disclosure. Therefore, the disclosed methods should be considered from an exemplary point of view for description rather than a limiting point of view. Even when the embodiments are described and the effects according to the configuration of the present disclosure are not explicitly described, effects that may be predicted by the configuration may also be recognized. The scope of the present disclosure is defined not by the detailed description of the present disclosure but by the appended claims and encompasses all modifications and equivalents that fall within the scope of the appended claims and will be construed as being included in the present disclosure.

What is claimed is:

1. A method of providing iron scrap classification information through image analysis, the method comprising:
receiving, by a receiving circuit, a loaded state image from a camera in a state where a plurality of iron scraps are loaded onto a loading device;
generating, by a processor, segmented images including a target iron scrap from the loaded state image using a segmentation model, wherein the segmentation model performs segmentation on the target iron scrap, which is one of the plurality of iron scraps;
generating, by the processor, item information and grade information that correspond to the target iron scrap using a classification model, wherein the classification model performs classification on the segmented images and analyzes the classified images on an image-by-image basis; and
providing, by the processor, iron scrap classification information that includes the item information and the grade information.

2. The method of claim 1, wherein the generating of the item information and the grade information includes:
generating, by the processor, a target iron scrap image representing the target iron scrap by excluding a background region from the segmented images; and
performing, by the processor, the classification on the target iron scrap image to generate the item information and the grade information.

3. The method of claim 2, further comprising:
receiving, by the receiving circuit, a correct image representing the target iron scrap;
determining, by the processor, a percentage of an overlapping region between the correct image and the target iron scrap image;
obtaining, by the processor, an iron scrap determination accuracy indicating whether the target iron scrap image corresponds to an actual image of iron scrap, when the percentage of the overlapping region exceeds a threshold overlap percentage; and
providing, by the processor, the iron scrap determination accuracy as a performance indicator.

4. The method of claim 2, further comprising:
determining, by the processor, a target weight based on a region size of the target iron scrap image;
determining, by the processor, a target accuracy for the target iron scrap image; and
applying, by the processor, the target weight to the target accuracy to determine an accuracy for the classification model.

5. The method of claim 1, further comprising:
receiving, by the receiving circuit, a single segmented image captured for a single iron scrap;
generating, by the processor, a synthesized image based on the loaded state image and the single segmented image; and
applying, by the processor, the segmentation model and the classification model to the synthesized image to provide additional iron scrap classification information.

6. The method of claim 5, wherein the generating of the synthesized image includes:
generating, by the processor, a single iron scrap image by excluding a background region from the single segmented image; and
generating, by the processor, the synthesized image by combining the loaded state image with the single iron scrap image.

7. The method of claim 6, wherein the generating of the synthesized image by combining the loaded state image with the single iron scrap image includes:
determining, by the processor, a number of possible combinations of the single iron scrap image and the loaded state image based on a region size of the single iron scrap image; and
generating, by the processor, the synthesized image based on the number of possible combinations.

8. The method of claim 1, wherein:
the receiving of the loaded state image includes receiving, by the receiving circuit, a loaded state image that is updated by being captured in a state in which positions of the plurality of iron scraps are updated in the loading device; and
the generating of the segmented images includes generating, by the processor, the segmented images including the target iron scrap from the updated loaded state image using the segmentation model.

9. The method of claim 4, wherein:
when a number of pixels included in the target iron scrap image is less than a first number, the target weight increases in proportion to a linear function corresponding to a first slope;
when the number of pixels is greater than or equal to the first number and less than a second number, the target weight increases in proportion to an exponential function having a base greater than the first slope; and
when the number of pixels is greater than or equal to the second number, the target weight increases in proportion to a linear function corresponding to a second slope smaller than the first slope,
wherein the first slope and the second slope have positive numbers, and the second number is greater than the first number.

10. The method of claim 1, wherein the providing of the iron scrap classification information includes:
obtaining, by the processor, average weight information indicating a cumulative area and/or cumulative number for each item and grade for the item information and grade information that correspond to the target iron scrap among the plurality of iron scraps; and
providing, by the processor, a circular graph showing a cumulative area ratio and/or cumulative number ratio for each item and grade for the target iron scrap in the loaded state image based on the average weight information.

11. An apparatus for classifying iron scrap that provides iron scrap classification information through image analysis, the apparatus comprising:
a receiving circuit configured to receive a loaded state image from a camera in a state where a plurality of iron scraps are loaded onto a loading device; and
a processor that is configured to:
generate segmented images including a target iron scrap from the loaded state image using a segmentation model, wherein the segmentation model performs segmentation on the target iron scrap, which is one of the plurality of iron scraps;
generate item information and grade information corresponding to the target iron scrap using a classification model, wherein the classification model performs classification on the segmented images and analyzes the classified images on an image-by-image basis; and
provide iron scrap classification information that includes the item information and the grade information.

12. The apparatus of claim 11, wherein the processor is configured to:
generate a target iron scrap image representing the target iron scrap by excluding a background region from the segmented image; and
perform the classification on the target iron scrap image to generate the item information and the grade information.

13. The apparatus of claim 12, wherein the receiving circuit receives a correct image representing the target iron scrap, and
the processor is configured to:
determine a percentage of an overlapping region between the correct image and the target iron scrap image;
obtain an iron scrap determination accuracy indicating whether the target iron scrap image corresponds to an actual image of iron scrap, when the percentage of the overlapping region exceeds a threshold overlap percentage;
provide the iron scrap determination accuracy as a performance indicator;
determine a target weight based on a region size of the target iron scrap image;
determine a target accuracy for the target iron scrap image; and
apply the target weight to the target accuracy to determine an accuracy for the classification model.

14. The apparatus of claim 11, wherein the receiving circuit receives a single segmented image captured for a single iron scrap, and
the processor is configured to:
generate a synthesized image based on the loaded state image and the single segmented image; and
apply the segmentation model and the classification model to the synthesized image to provide additional iron scrap classification information.

15. A computer-readable recording medium on which a program is recorded, the program comprising instructions that, when executed by a processor, cause the processor to:
receiving a loaded state image from a camera in a state where a plurality of iron scraps are loaded onto a loading device;
generating segmented images including a target iron scrap from the loaded state image using a segmentation model, wherein the segmentation model performs segmentation on the target iron scrap, which is one of the plurality of iron scraps;
generating item information and grade information that correspond to the target iron scrap using a classification model, wherein the classification model performs classification on the segmented images and analyzes the classified images on an image-by-image basis; and
providing iron scrap classification information that includes the item information and the grade information.

16. The computer-readable recording medium of claim 15, wherein when executed by a processor, the instructions causes the processor to:
generate a target iron scrap image representing the target iron scrap by excluding a background region from the segmented image; and
perform the classification on the target iron scrap image to generate the item information and the grade information.

17. The computer-readable recording medium of claim 16, the program further comprising instructions to receive a correct image representing the target iron scrap,
wherein the instructions causes the processor to:
determine a percentage of an overlapping region between the correct image and the target iron scrap image;
obtain an iron scrap determination accuracy indicating whether the target iron scrap image corresponds to an actual image of iron scrap, when the percentage of the overlapping region exceeds a threshold overlap percentage;
provide the iron scrap determination accuracy as a performance indicator;
determine a target weight based on a region size of the target iron scrap image;
determine a target accuracy for the target iron scrap image; and
apply the target weight to the target accuracy to determine an accuracy for the classification model.

18. The computer-readable recording medium of claim 15, the program further comprising instructions to receive a single segmented image captured for a single iron scrap, and
wherein the instructions causes the processor to:
generate a synthesized image based on the loaded state image and the single segmented image; and
apply the segmentation model and the classification model to the synthesized image to provide additional iron scrap classification information.
